(19) United States
(12) Patent Application Publication
(10) Pub. No.: US 2007/0232155 A1
(43) Pub. Date: Oct. 4, 2007

(54) Quick Release Connector Apparatuses, Methods and Systems

(76) Inventor: Robert M. FREY, Salt Lake City, UT (US)

Correspondence Address: PATENT GROUP 2N;JONES DAY, NORTH POINT, 901 LAKESIDE AVENUE, CLEVELAND, OH, 44114, US

(21) Appl. No.: 11/683,428

(22) Filed: Mar. 7, 2007

Related U.S. Application Data
(60) Provisional application No. 60/743,427, filed on Mar. 7, 2006.

(51) Int. Cl. H01R 4/50

(52) U.S. Cl. 439/783

(57) ABSTRACT

A connector assembly, method and system for connecting a first tube section to a second tube section or for attaching a single tube member or section to a structure. One embodiment includes an upper body with at least an upper arm, a base body with at least a lower arm, a handle, and a securing fastener wherein the upper body and the lower body are positioned within the open ends of one or more tubular sections so that when the handle is engaged the base body and the upper body together define a cooperating wedge for urging at least a portion of the upper and lower arms in an outward direction so that force is applied towards the interior surfaces of the one or more tubular sections being connected.

### CROSS-REFERENCES TO RELATED APPLICATIONS

This application claims the benefit of U.S. Provisional Application Ser. No. 60/743,427 filed Mar. 7, 2006 which is incorporated herein by reference in its entirety.

### STATEMENT REGARDING FEDERALLY SPONSORED RESEARCH OR DEVELOPMENT

None.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

The claimed subject matter relates to connectors for connecting together sections of tubing and is particularly suitable for connecting together sections of hollow, cylindrical, metal tubing which have axially oriented, folded metal seams extending longitudinally on the inside of the tubing.

2. The Related Art

Various connectors known in the prior art have been used with a variety of products which require the rigid joining of hollow, cylindrical tubing made of metal or other materials. Examples of these products include television stands, infant seats, and trade show displays.

One type of widely used tubing is fabricated in a cylindrical form from sheet metal and this type of tubing has an internal, longitudinal seam of overlapping, folded, sheet metal. While conventional connectors in use today can be used with such internal seam tubing, such conventional connectors do not accommodate such tubing in a manner that permits a tube section to be attached or detached without using conventional tools.

There is a need for an inexpensive and visually appealing device and method to fasten hollow tubes together securely and without the use of tools. For example, in many environments where display assemblies and systems are used, the use of tools to connect the displays requires that a local union perform all display system assembly and erection which can be costly and can delay the setup. Other connectors use snap fit connections which use a male/female connector and a pin. One problem with these connectors is that the connections between the tube members are difficult to maintain in a secure or rigid state.

### SUMMARY

Embodiments of the claimed subject matter provide improved connector apparatuses, methods and systems which can be easily installed, fastened and unfastened without the need to use additional tools. Embodiments also permit quick adjustment of one of the tube sections to any selected rotational orientation. For example, the connector may accommodate the internal seam of a tube section and permit that tube section to be rotated to any desired position as may be necessary to properly orient other structures, such as casters, that are mounted to the tube section, and then quickly locked into place.

Embodiments include connector assemblies for connecting a first tube section to a second tube section or for attaching a single tube member or section to a structure. One aspect includes a quick-release cam lock arrangement for connecting to one or more tube members comprising an upper body, one or more upper arms, a base body, one or more base arms, a handle, a fastener means for matedley engaging the upper body and the lower body and for extending the arms outwardly into the interior surface of one or more hollow tube members, and a threaded means for providing a cam action in cooperation with the handle.

One embodiment of the connector apparatus includes an upper body with at least an upper arm, a base body with at least a lower arm, a handle, and a securing fastener wherein the upper body and the lower body are positioned within the open ends of one or more tubular sections so that when the handle is engaged the base body and the upper body together define a cooperating wedge for urging at least a portion of the upper and lower arms in an outward direction so that force is applied towards the interior surfaces of the one or more tubular sections being connected.

Embodiments of the quick release tube connectors may be quickly connected and disconnected between lengths of tubing in a selected one of a large number of relatively axial adjustment positions. While capable of a very wide range of uses, the embodiments may also be used with walking aids such as canes, crutches and walkers constructed of aluminum or magnesium tubing. The handle can be oriented to obstruct the ends of the transverse bore when positioned over the tube connector 10 such that the latch pin cannot be moved from the locked position to the released position.

### BRIEF DESCRIPTION OF THE DRAWINGS

In the accompanying drawings forming part of the specification, in which like numerals are employed to designate like parts throughout the same,

FIG. 1 is a component view of an embodiment of the claimed subject matter;

FIG. 2 is perspective side view of an embodiment of the claimed subject matter;

FIG. 3 is perspective side view of an embodiment of the claimed subject matter as used with a tube member at either side; and

FIG. 4 is an exploded view of an embodiment of the claimed subject matter.

### DETAILED DESCRIPTION OF THE EMBODIMENTS

In the following description, numerous specific details are set forth, such as component names and descriptions of components used in the context of tubular supports in order to provide a thorough understanding of the various embodiments of the claimed subject matter. One skilled in the relevant art will recognize, however, that these embodiments can be practiced without one or more of the specific details, or with a number of other methods or components.

References throughout this specification to “one embodiment” or “an embodiment” means that a particular feature, structure, or characteristic described in connection with the embodiment is included in at least one embodiment of the present claimed subject matter. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It will be noted here that for a better understanding the components are designated by like reference numerals throughout the various figures in the embodiments wherein the following components include:
a quick release tube connector 10;
an upper body 12;
an upper arm 14;
a base body 16;
a base arm 18;
a handle 20;
a fastener means 22;
a threaded means 24;
a saddle nut 26; and
a tube member 28.

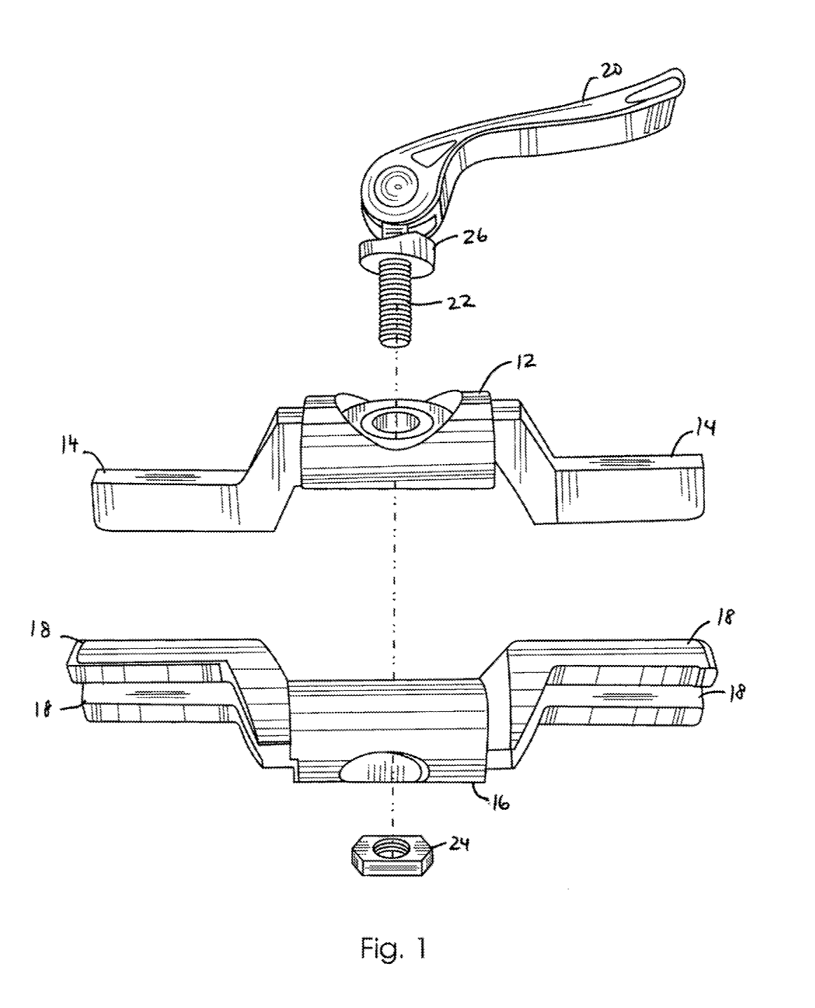

Referring now to FIG. 1, the illustrated components of an embodiment can be used to join or connect a first tubular section (tube section) to a second tubular section. In other embodiments, the connector may be permanently connected to an article or another tubular section on an article and the connector may be used to connect that already connected tube, tubular section or article to a single hollow tubular section.

The illustrated embodiments can also be used with any solid, substantially hollow or hollow tube shaped sections or members. Further, the embodiments of the present invention are illustrated as being used with cylindrical tube sections that can be used with conventional tubing products, but embodiments may also be adapted to connect or join non-cylindrical tube sections such as rectangular or any other shaped sections. For example, an octagon shaped tubular section may be used for one or both sections being joined. The sections being joined may also be constructed of different sizes and shapes and the connector components may also be varied in size and shape. For example, one side of the connector apparatus may be smaller than the opposing end side so that the connector apparatus better accommodates sections of differing sizes.

In another embodiment, the tubing sections may be hollow (or with an interior cavity sufficiently large to accept the upper and lower arms of one side of the connector apparatus) and made from metal or other suitable material such as plastic, and typically having an internal seam. Further, tubing used with the described embodiments may be fabricated from metal which is formed into a tubular configuration with interlocking, overlapped layers defining an interior seam.

FIG. 1 illustrates the components of the connector 10 and their relationship to each other. The connector 10 assembly includes an upper body 12 with upper arms 14 positioned on the left and the right side of the body 12. The connector 10 assembly also includes a base body 16 with base arms 18 positioned on the left and the right side of the base body 16. The upper body 12 and the base body 16 are matingly engaged into each other using a fastener 22 which has an extended threaded portion and is attached to both the saddle nut 26 and the handle 20.

Further, the connector 10 includes a threaded receiver 24, shown as the nut 24 in FIG. 1, for threadingly receiving the threaded fastener 22 and urging the base body 16 axially into a mating engagement with the upper body 12. Other configurations other than axially are also possible to that the upper and lower bodies are also matingly engaged.

The base body 16 and the upper body 12 members together define a cooperating wedge means for urging at least a portion of the arms 14 and 18 to apply force in an outward direction. In use, the rotation of the handle 20 causes the base body 16 and the upper body 12 to be increasingly axially engaged, leading to increasing force in the arms 14 and 18 which cause a tight engagement with the interior walls of a hollow tubed segment. This outwardly radial force secures the arms against the interior walls of a tubed segment being joined holding at least the connector 10 and the tubed segment fixed in place. The cam ratio and arm length is set to allow a person with average hand strength to exert a sufficient amount of force to securely hold in place one or two tube segments on one or both sides of the connector 10.

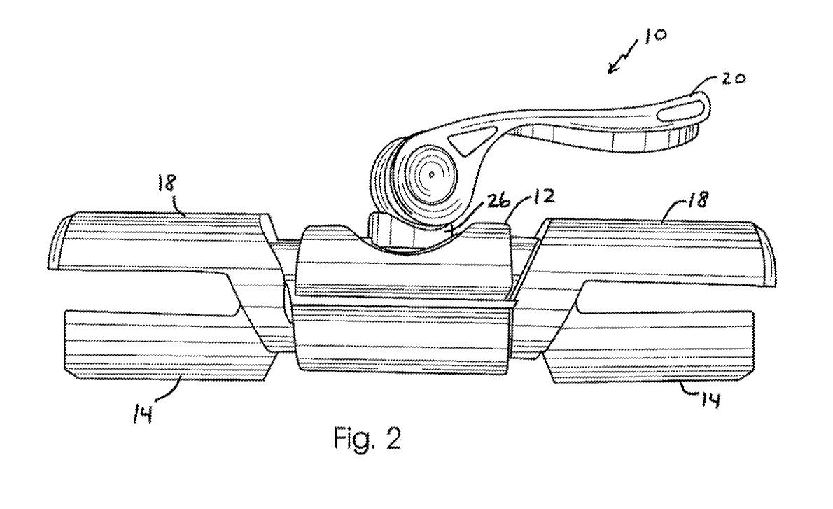

FIG. 2 illustrates an embodiment that has been axially engaged so that the base body 16 and the upper body 18 are in a tight engagement. The arms 14 and 18 are illustrated with surfaces shaped in saddle configurations positioned outwardly towards the surface of the interior of a hollow tube member. In this position, the connector 10 may be positioned within one or two tubular sections before being engaged to hold the tubular sections in a fixed position relative to each other. The tubular sections may be allowed to freely rotate or they may be fixed in a rotational position by the force of the arms.

In this embodiment, the handle 20 has been first rotated and used as a cam means to outwardly engage the upper arms 14 and the base arms 18, and then depressed so that the handle 20 is in alignment with the arms. The arms 14 and 18 may also extend to only one side of the bodies 12 and 16, such as when the connecter is attached on one side (opposite to the tubular member being joined) to a structure or assembly such as an adjustable foot or stand assembly (Not Shown.)

The threaded fastener 22 shown in this embodiment is a threaded shank which is threadingly engaged to a saddle nut 26. An upper aperture or cavity is provided at the top of the upper body 12 in alignment with the lower aperture (not shown) found at the underside or bottom of the base body 16. Also not shown in FIG. 2 is the threaded receiver, such the nut 24, which fits into the base body cavity and which secures the threaded shank of the fastener 22 to the base body 16.

As shown in FIG. 2, the one or more arms of connector 10 may have a saddle or vault shaped curvature on the outer surfaces of the arms for being received on the interior cylindrical surface of the tube members 28. In this way, a larger surface area can be utilized in order to securely hold the connector 10 to the interior of tubular member 28. Also, the arms and bodies may be constructed of a material that is resiliently deformable such as a thermoplastic material. Materials such as the aforementioned may be used to avoid damaging the tubular members 28 or the connector 10.

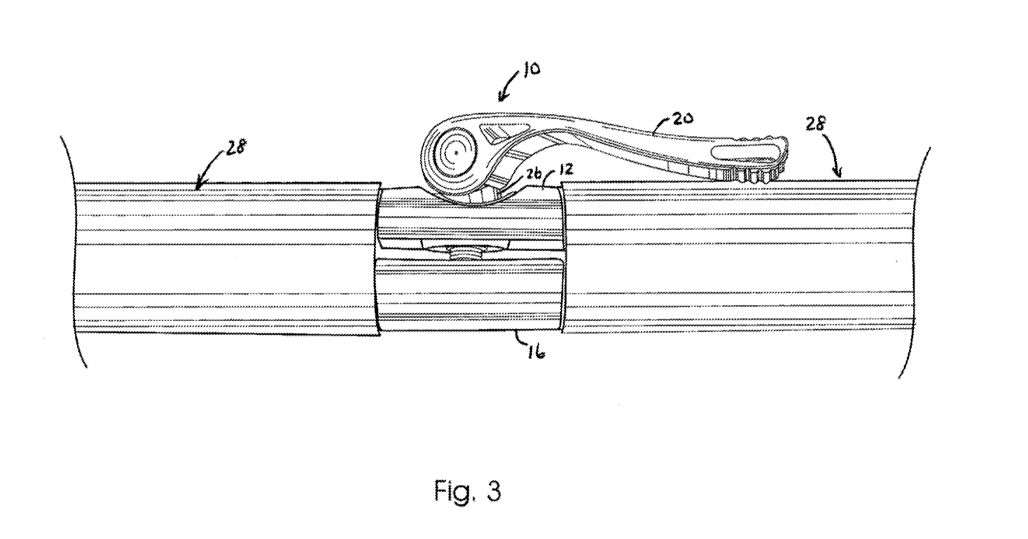

As illustrated in FIG. 3, the upper body 12 and the base body 16 are aligned with the fastener 22 and matingly engaged. The upper body 12 has a cavity for accommodating the saddle shaped nut 26 while the cavity for receiving the threaded means 24 in the lower surface of the base body 16 is not shown. This lower cavity acts both for receiving the nut 24 and for limiting the axial movement of the nut 24 as well as the fastener means 22 relative to the base body 16.

In several embodiments, the threaded means 24 or nut 24 may be slid into the cavity of the base body 16 from the open side of the cavity. Although the nut 24 is illustrated as a separate, and removable, conventional component, it is to be understood that the base body 16 may be provided with threaded receiving means 24 formed integral or unitary with the base body 16. However, adjustability of the connector 10 may be enhanced by providing a separate threaded receiving means 24.

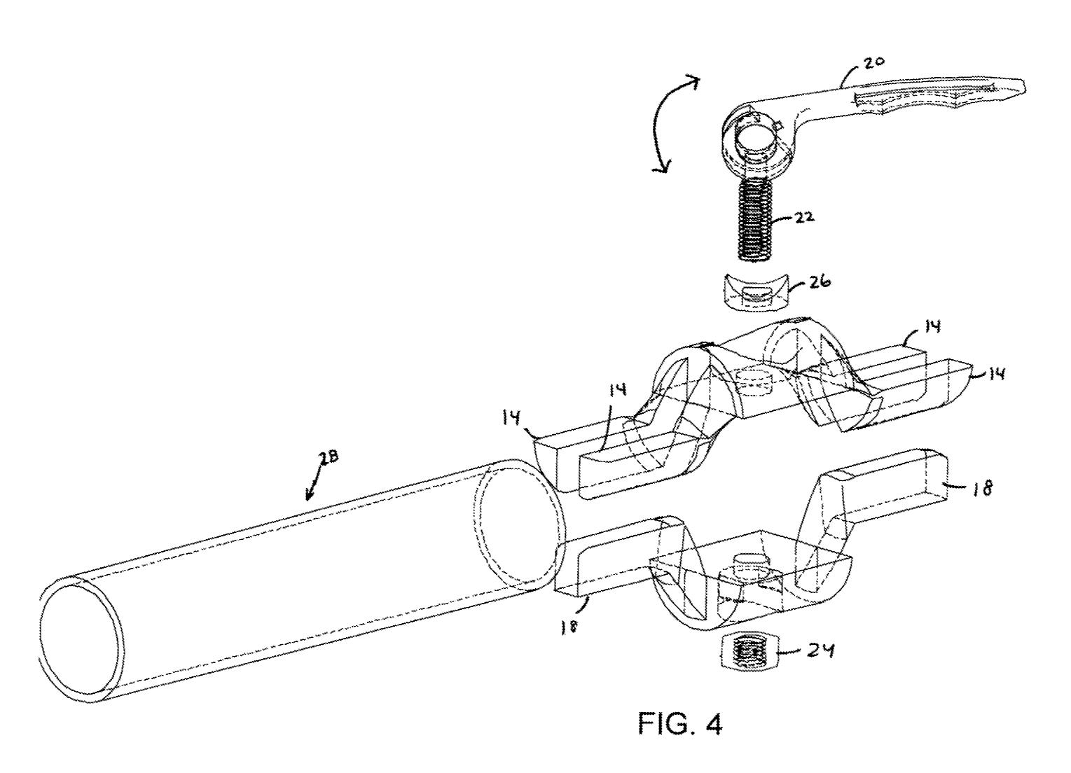

FIG. 4 is an exploded view of an embodiment showing the direction of the handle 20 travel when placed in use. Directional movement of the handle 20 causes leverages the cam saddle 26 and causes the upper body 12 and the base body 16 to being moving together. At the same time, arms 14 and 16 are moved outward into the interior walls of the tubular members 28, shown on one side of the connector 10 in FIG. 4.

The handle 20 may be additionally recessed to a complementary slot in one of the tube members 28 once the bodies 12 and 16 have been matingly engaged. However, when the connector assembly components are in an untightened, loose position as illustrated in FIG. 1, the movement of the handle 20 is unrestricted. To loosen and separate the connector 10 from the one or more tube members 28, the handle 20 is rotated by the user in the opposite, loosening direction until the tube member 28 is disengaged from the arms at which point the tube member 28 can be pulled away from the tube connector 10 or rotated to a new desired position.

If rotated to a new position, the tube member 28 or tube section can be pushed forwardly again toward the connector 10 and against the bodies 12 and 16, and the screw 22 can then be rotated in the tightening direction to again effect a tight engagement between the connector 10 and the member 28. The handle 20 may be a cam locking type handle or it may be a simple control for a screw. In the embodiments illustrated in FIGS. 1 through 3, the handle can rotate in order to screw the handle into the upper body 12 and the base body 16. This adjustment can be used to position the handle 20 in a tightened configuration while it is extended, and then the handle 20 may be used as a lever to provide additional torque and resulting tightening of the connector 10. This lever action which can generate an increased level of force with the use of the handle/cam assembly has been well described and is well known in many other apparatuses, for example in cams used for making adjustments to bicycle seats. Any known handle/screw/cam element may be used to apply tension to the bodies 12 and 16 and thus applying outward force from the arms 14 and 18 to the interior of the tube member 28.

In this fashion, two tube members 28 may be connected together in an axial or co-linear relationship so that they are secured from the inside of those tube members without having exterior components to physically or visually obstruct the remaining apparatus components. In low profile embodiments, the handle 20 may also recess into the side or exterior surface of one of the tube members 28.

The illustrated embodiments of the arms and body may be constructed die cast aluminum, zinc, thermoplastic or any other suitable material. The nut 24, saddle nut 26 and threaded screw used as the fastener means 22 screw can be machined parts constructed of steel, plastic or any other suitable material.

The tube members of the illustrated embodiments may be of any suitable size and dimension, for example, 1.250″ in outer diameter and 1.084″ in interior diameter. Connectors 10 may be fabricated to accommodate any sized tube member, and the range of the sizes of the fastener 22 may also be suitably adjusted. Additionally, tube members 28 of differing diameters may also be used with one or more connectors.

Additionally, the length of the arms 14 and 18 may be fixed or the lengths may be variable, for instance the length may be chosen because of the desirability for support in a specific use or application involving the connector 10. In one embodiment, variable arms may be extendable by the user so they can provide additional support or less support as desired by the user in the field. In another embodiment, one set length of the tube members 28 may be used for connecting the two tube members 28 in a display with multiple tube members which can be used with multiple connectors 10. Other configurations will also be apparent to one skilled in the art.

In some embodiments, the arms may be of a suitable length so that they sufficiently “lock” against the inside of the tube member being connected, or if two tube members, each arm can be long enough to lock into their respective connecting tube members so that the tube member or members are held securely. In other embodiments, the arms may be shorter holding the tube members 28 insecurely so as to provide a “break away” effect. The arms may also be loose enough so that the tube members 28 may be rotated freely while still being joined by the connector 10.

In other applications, longer arms may be desired. For example, longer arms may be used when one tube segment must resist rotational force. For example, in the case wherein one segment has rotational force applied to it while at the same time the other tube member 28 has no rotational force being applied to it. In another embodiment, one tube member 28 may be pulled axially away from the other tube, for example when a quick release is desired by the user. By increasing the length of the arms, the surface area in contact between the arms and the interior wall of the tube segments can be increased and this increase in surface area leads to an increase friction and holding and thus greater stability between the connector 10 and the segments 28.

Similarly, the length of the arm and the size of the cam will also influence the strength of the connector 10 as the length of the arm and the size of the fastener 22, such as a threaded screw cooperating with the handle 20, can be increased to increase the holding capability of the connector 10. In use, a user operates the handle 20 with his or her hand in order to generate an amount of force sufficient to actuate the fastener 22, in this embodiment a cam, so that the arms engage and hold the tube members 28 in place.

In addition to the arms being of variable length or of varying fixed lengths, the diameter and configuration of the arms can also vary depending on the strength and leverage desired. Many applications require only minimal forces applied to the connector 10 and in those instances, arms with a short length may be suitable.

The exterior of the arms and/or the interior cavities of the tube members may also be coated with a substance such as rubber, Teflon or the like in order to increase the friction between the connector and the interior of the tube members. Similarly, the exterior surface of the arms and/or the interior cavities of the tube members may also be made of a rough or knurled surface in order to increase friction resulting in increased holding power.

Other embodiments can use the arms positioned so that they are fitted together in direct contact such as metal on metal, metal on plastic, or plastic on plastic arms. Additionally, anything that may be bonded to the arms could increase surface friction between the arms and the interior wall of the hollow tube member and lead to increased friction and resulting holding strength of the connector.

In some embodiments, various alloys may be used to vary the strength of the bodies and arms. For a given alloy being used, such as aluminum, the cross section of the arms should be of sufficient size to handle the loads being applied by the levering of the arm. For example if the arms were constructed of a shorter length than required for a particular load, one or both of the arms could break. These embodiments maximize each of the arms cross sections along their entire length to increase the surface area in contact with the interior of the tube members and to aid in avoiding failure of the arms and connector. As previously described, it may also be desirable to provide embodiments that break away or fail at a certain point.

In an embodiment used for attaching a single tube member 28 to an article or an apparatus or a fixed sheet of material, the connector 10 attaches to the article from the inside using the expansion of the arms to secure the connector to the article, thus providing a smooth exterior surface on all sides of the hollow portion in the article. This configuration would allow the connector to sit flush against other devices, structures or items, such as a chair, table, floor or wall.

The handle 20 may also be configured to be recessed or hidden inside an adjacent secured or unsecured tube member when the handle is not in use. Further, the base body 16 and the upper body 12 may also include one or more longitudinally oriented slots for accommodating or receiving an interior seam of a tube member 28.

The releasable attachment mechanisms which can be used with embodiments of the claimed subject matter include a latch pin (not shown) that can be positioned in transversely extending bores of the support base. The latch pin may be slideable between a released position wherein the connector 10 can be detached/attached from the tube member and a locked position wherein the connector 10 cannot be so removed.

In several embodiments, the connector 10 may be designed so that the arms are replaced with tube segments which are placed over the tube members 28 in order to hold the tubular members in a co-linear or perpendicular relationship with each other. This embodiment would also hold the tube members 28 so that they could be quickly released from each other using the quick release cam mechanism described herein.

Other embodiments of the claimed subject matter can use any known cam locking mechanism with the ability to apply pressure to the interior walls of a substantially hollow structure or hollow structures whereby the cam locking mechanism holds those interiors in a fixed or stable position.

In other embodiments, these apparatuses may include tubular or rectangular structures and supports having interior cavities, for instance structures and supports associated with vehicles, furniture and wheelchairs.

While the detailed description of the claimed subject matter has been described with reference to multiple embodiments, it should be understood by those skilled in the art that various changes and modifications may be made and equivalents may be substituted for elements thereof without departing from the scope of the claimed subject matter. Therefore, the claimed subject matter is not limited to the various disclosed embodiments including the best mode contemplated for carrying out the claimed subject matter, but instead includes all possible embodiments that fall under the subject matter to be claimed.

What is claimed is:

1. A connector apparatus for connecting a tubular section to another tubular section comprising:
an upper body with at least an upper arm;
a base body with at least a lower arm;
a handle; and
a securing fastener;
wherein said upper body and said lower body are positioned within the open ends of said tubular sections so that when said handle is engaged said base body and said upper body together define a cooperating wedge for urging at least a portion of said upper and lower arms in an outward direction so force is applied towards the interior surfaces of the tubular sections being connected from the at least one upper arm and at least one lower arm.

2. The connector apparatus for connecting a tubular section to another tubular section of claim 1 wherein one of said tubular sections is encompassed in another device or apparatus.

3. The connector apparatus for connecting a tubular section to another tubular section of claim 1 further comprising a securing fastener to hold the tubular sections in place.

4. The connector apparatus for connecting a tubular section to another tubular section of claim 1 wherein the handle can be recessed into the exterior of a tubular member.

5. The connector apparatus for connecting a tubular section to another tubular section of claim 1 wherein one or more of said arms used to hold the tubular sections in place have a saddle or vault shaped curvature on the outer surfaces of said one or more arms.

6. The connector apparatus for connecting a tubular section to another tubular section of claim 1 wherein the arms are variable in length.

7. The connector apparatus for connecting a tubular section to another tubular section of claim 1 wherein the arms are of varying fixed lengths.

8. The connector apparatus for connecting a tubular section to another tubular section of claim 1 wherein the arms are of varying diameter and configuration.

9. The connector apparatus for connecting a tubular section to another tubular section of claim 1 wherein the exterior surface of one or more of said arms are coated with a substance in order to increase the friction between the connector and the interior of one or more of said tubular members.

10. The connector apparatus for connecting a tubular section to another tubular section of claim 1 wherein the interior surface of said one or more tubular members is coated with a substance in order to increase the friction between the connector and the interior of one or more of said tubular members.

11. The connector apparatus for connecting a tubular section to another tubular section of claim 1 wherein said arms are constructed of a length so that they maintain the connector apparatus against the inside of the tube member being connected.

12. The connector apparatus for connecting a tubular section to another tubular section of claim 1 wherein said arms are constructed of a length so that they allow the tubular members to be rotated while maintaining the connector apparatus against the inside of the tube member being connected.

13. The connector apparatus for connecting a tubular section to another tubular section of claim 1 wherein the exterior surface of one or more of said arms are roughened in order to increase the friction between the connector and the interior of one or more of said tubular members.

14. The connector apparatus for connecting a tubular section to another tubular section of claim 1 wherein the interior surface of said one or more tubular members is roughened in order to increase the friction between the connector and the interior of one or more of said tubular members.

15. The connector apparatus for connecting a tubular section to another tubular section of claim 1 wherein said handle is recessed within a tubular member when said handle is not in use.

16. The connector apparatus for connecting a tubular section to another tubular section of claim 1 further comprising a releasable attachment mechanism having a latch pin positionable in transversely extending bores located though said upper and lower bases of said connector.

17. The connector apparatus for connecting a tubular section to another tubular section of claim 16 wherein said latch pin is slideable between a released position wherein said connector can be detached or attached from the tubular member and a locked position wherein said connector cannot be detached from the tubular member.

18. The connector apparatus for connecting a tubular section to another tubular section of claim 1 wherein one or more of said upper or lower arms are constructed of tube segments which can be positioned over one or more of said tube members in order to secure the tubular members in a co-linear or perpendicular position in relation to each other.

19. A method of connecting a tubular section to another tubular section using a connector with an upper body with at least an upper arm, a base body with at least a lower arm, a handle, and a securing fastener, comprising the steps of:
positioning said upper body and said lower body within the open ends of said tubular sections so that when said handle is engaged said base body and said upper body member together define a cooperating wedge for urging at least a portion of said upper and lower arms in an outward direction; and
positioning the handle and securing fastener so as to apply force from the at least one upper arm and at least one lower arm towards the interior surfaces of the tubular sections being connected.

20. A system of connecting two or more tubular sections comprising a connector and two or more tubular sections, the connector comprising:
an upper body with at least an upper arm;
a base body with at least a lower arm;
a handle; and
a securing fastener;
wherein said upper body and said lower body are positioned within the open ends of said tubular sections so that when said handle is engaged said base body and said upper body together define a cooperating wedge for urging at least a portion of said upper and lower arms in an outward direction so force is applied towards the interior surfaces of the tubular sections being connected from the at least one upper arm and at least one lower arm.
